(19) United States
(12) Patent Application Publication
(10) Pub. No.: US 2013/0038893 A1
(43) Pub. Date: Feb. 14, 2013

(54) INFORMATION PROCESSING APPARATUS AND STORAGE MEDIUM

(71) Applicants: Ryohichi Katoh, Kanagawa (JP); Takashi Soyama, Kanagawa (JP); Hiroki Asakimori, Tokyo (JP); Soichi Nakamura, Kanagawa (JP)

(72) Inventors: Ryohichi Katoh, Kanagawa (JP); Takashi Soyama, Kanagawa (JP); Hiroki Asakimori, Tokyo (JP); Soichi Nakamura, Kanagawa (JP)

(21) Appl. No.: 13/583,239

(22) PCT Filed: Mar. 9, 2011
(86) PCT No.: PCT/JP2011/056135

§ 371 Date: Sep. 7, 2012

(30) Foreign Application Priority Data
Mar. 9, 2010 (JP) 2010-051672
Feb. 4, 2011 (JP) 2011-022732

(51) Int. Cl. G06K 15/02

(52) U.S. Cl. 358/1.14

(57) ABSTRACT

An information processing apparatus includes a request-frequency calculating unit, an acceptable-frequency calculating unit, and acceptance/rejection determining unit. The request-frequency calculating unit calculates a request frequency corresponding to a processing request relating to image formation with reference to any one of multiple pieces of frequency information, which is broken down by process category of an image forming process and stored in a predetermined storage unit, selectively. The acceptable-frequency calculating unit calculates an acceptable frequency corresponding to the processing request from acceptable-processing-amount information stored in a predetermined storage unit. The acceptance/rejection determining unit determines whether or not to accept the processing request by comparing the request frequency with the acceptable frequency.

### TECHNICAL FIELD

The present invention relates to an information processing apparatus and a storage medium.

### BACKGROUND ART

Conventionally, there is known an image forming apparatus capable of making per-user settings for an acceptable amount of an image forming process, such as the number of copies or the number of sheets printed. One such example is disclosed in Japanese Patent Application Laid-open No. 2005-341133.

However, in an image forming apparatus disclosed in Japanese Patent Application Laid-open No. 2005-341133, an acceptable amount is set to a fixed (one type of) amount, so it is difficult to respond to management of a more efficient processing amount depending on the situation.

### DISCLOSURE OF INVENTION

An object of the present invention is to provide at least an information processing apparatus and storage medium capable of managing an acceptable amount of processing relating to image formation more easily and more efficiently.

According to an aspect of the present invention, an information processing apparatus includes a request-frequency calculating unit that calculates a request frequency corresponding to a processing request relating to image formation with reference to any one of multiple pieces of frequency information, which is broken down by process category of an image forming process and stored in a predetermined storage unit, selectively; an acceptable-frequency calculating unit that calculates an acceptable frequency corresponding to the processing request from acceptable-processing-amount information stored in a predetermined storage unit; and an acceptance/rejection determining unit that determines whether or not to accept the processing request by comparing the request frequency with the acceptable frequency.

According to another aspect of the present invention, a computer-readable, non-transitory medium stores a program causing a computer to execute: calculating a request frequency corresponding to a processing request relating to image formation with reference to any one of multiple pieces of frequency information which is broken down by process category of an image forming process and stored in a predetermined storage unit, selectively; calculating an acceptable frequency corresponding to the processing request from acceptable-processing-amount information stored in a predetermined storage unit; and determining whether or not to accept the processing request by comparing the request frequency with the acceptable frequency.

The above description and the other objects, features, and advantages of the present invention are clarified in the following detailed description of the invention with reference to the accompanying drawings.

### BRIEF DESCRIPTION OF DRAWINGS

FIG. 1 is a schematic diagram showing an example of a configuration of an MFP as an information processing apparatus according to an embodiment of the present invention;

FIG. 2 is a block diagram showing an example of a functional configuration of the MFP as the information processing apparatus according to the embodiment of the present invention;

FIG. 3 is an explanatory diagram showing an example of user information, frequency information, user attribute information, specification information, and weighting information stored in a storage unit of the MFP as the information processing apparatus according to the embodiment of the present invention and an example of a functional configuration for setting and acquisition of the information;

FIG. 4 is an explanatory diagram showing another example of the specification information stored in the storage unit of the MFP as the information processing apparatus according to the embodiment of the present invention;

FIG. 5 is a diagram showing an example of a functional block of an SCS included in the MFP as the information processing apparatus according to the embodiment of the present invention;

FIG. 6 is an explanatory diagram showing an example of the flow of an acceptance/rejection determining process and a processing-performance updating process (changing process) in the MFP as the information processing apparatus according to the embodiment of the present invention;

FIG. 7 is a flowchart showing an example of the acceptance/rejection determining process in the MFP as the information processing apparatus according to the embodiment of the present invention; and

FIG. 8 is a flowchart showing an example of the processing-performance updating process (changing process) in the MFP as the information processing apparatus according to the embodiment of the present invention.

### BEST MODE(S) FOR CARRYING OUT THE INVENTION

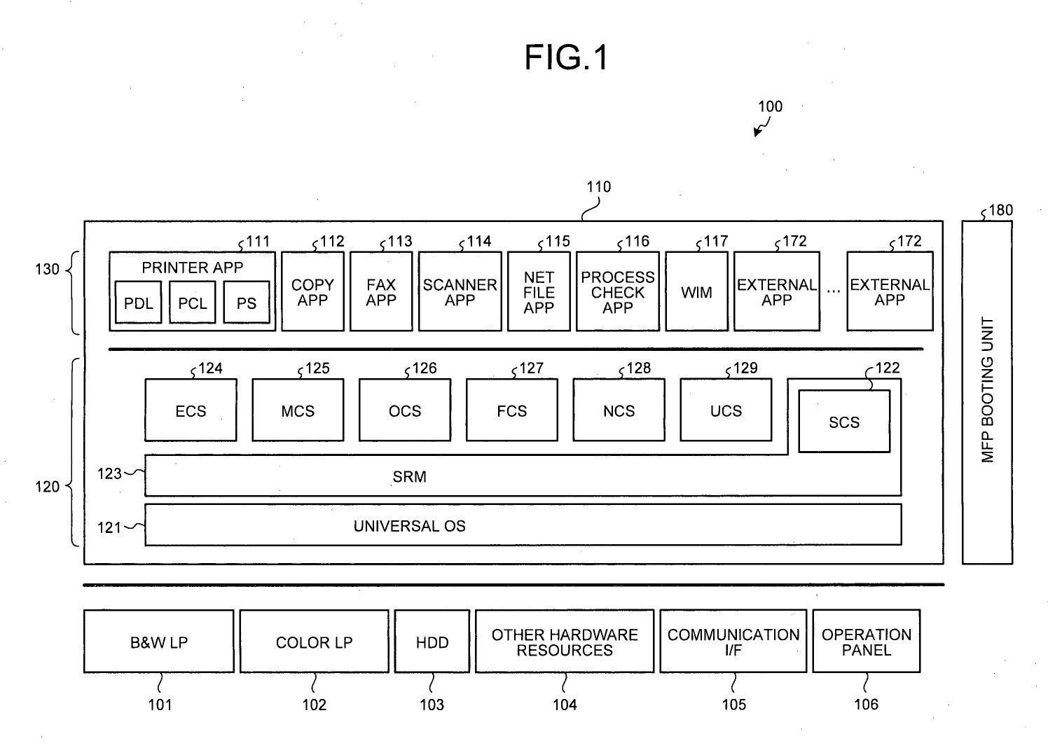

An embodiment of the present invention is explained in detail below with reference to the accompanying drawings. First, the major function of a multifunction peripheral (MFP) 100 as an information processing apparatus (an image forming apparatus) according to the present embodiment is explained with reference to FIG. 1.

The MFP 100 includes a black-and-white laser printer (B&W LP) 101, a color laser printer (Color LP) 102, an HDD 103, hardware resources 104 such as a scanner, a facsimile machine, and a memory, a communication I/F (interface) 105, and an operation panel 106, and is equipped with a software group 110 composed of a platform 120 and an application 130.

The platform 120 includes a control service which interprets a processing request from the application 130 and issues a hardware-resource acquisition request, a system resource manager (SRM) 123 which manages one or a plurality of hardware resources and mediates an acquisition request from the control service, and a universal OS (Operating system) 121.

The control service is formed of a plurality of service modules, and includes an SCS (system control service) 122, an ECS (engine control service) 124, an MCS (memory control service) 125, an OCS (operation-panel control service) 126, an FCS (fax control service) 127, an NCS (network control service) 128, a UCS (user control service) 129, and the like. The platform 120 further includes an application program interface (API) which allows receiving of a processing request from the application 130 by a predefined function.

The universal OS 121 is a universal operating system such as UNIX (registered trademark), and is capable of parallel execution of software of the platform 120 and the application 130 as processes.

The SRM 123 performs control of the system and management of the resources together with the SCS 122. A process of the SRM 123 is mediation in accordance with a request from an upper layer using hardware resources, engines of a scanner unit and a printer unit, etc., a memory, an HDD file, and a host I/O (such as a Centronics I/F, a network I/F, an IEEE1394 I/F, and an RS232C I/F), and control of execution.

Specifically, the SRM 123 determines whether a requested hardware resource is available (whether or not a requested hardware resource is used for another request), and if the hardware resource is available, the SRM 123 informs the upper layer that the requested hardware resource is available. Furthermore, the SRM 123 performs scheduling use of a hardware resource in response to a request from the upper layer, and directly implements the content of the request (for example, conveyance of a sheet and imaging operation by a printer engine, securing of a memory, creation of a file, etc.).

A process of the SCS 122 is management of app (applications), control of an operating unit, system screen display, LED display, management of resources, control of an interrupt app, a process relating to determination of whether or not to accept an image forming process, and the like.

A process of the ECS 124 is control of engines of the black-and-white laser printer (B&W LP) 101, the color laser printer (Color LP) 102, and the hardware resources 104 such as the scanner and the facsimile machine.

A process of the MCS 125 is acquisition and release of an image memory, utilization of the hard disk drive (HDD) 103, compression and decompression of image data, and the like.

A process of the OCS 126 is control of the operation panel 106 as a means of transmitting information between an operator (a user) and the main body control. The OCS 126 includes an OCS process part and an OCS library part. The OCS process part obtains a press (or a touch) of a key from the operation panel 106 as a key event, and transmits a key event function corresponding to the obtained key to the SCS 122. In the OCS library part, a drawing function for drawing/outputting various screens onto the operation panel 106 in accordance with a request from the application 130 or the control service, a function for controlling the operation panel 106, and the like are registered in advance. The OCS library is mounted to be linked to the application 130 and the modules of the control service. The entire OCS 126 can be configured to operate as the OCS process, or can be configured as the OCS library.

A process of the FCS 127 is to provide an API for performing sending and receiving of a fax using a PSTN/ISDN network from each application layer of the system controller, registration/citation of various facsimile data managed by a BKM (a backup SRAM (Static Random Access Memory)), reading of a facsimile, receiving and printing of a facsimile, and fusional sending and receiving.

A process of the NCS 128 is a process for providing a commonly available service to an application which requires a network I/O, and the NCS 128 performs sorting of data received from the network side by each protocol into applications and mediation when data from an application is transmitted to the network side.

A process of the UCS 129 is management of user information. Namely, the process of the UCS 129 is to determine a storage unit in which information meeting a request is stored, acquire user information from the determined storage unit, and provide the user information to an application. Furthermore, the process of the UCS 129 includes determination of a storage unit in which user information meeting a request is stored and update of the user information stored in the determined storage unit.

The application 130 is for executing respective processes specific to user services relating to an image forming process, such as a printer, copy, facsimile, and a scanner. The application 130 includes a printer app 111 which is an application for a printer having a page-description language (PDL), a printer control language (PCL), and PostScript (PS); a copy app 112 which is an application for copying; a fax app 113 which is an application for a facsimile; a scanner app 114 which is an application for a scanner; a net file app (NFA) 115 which is an application for a network file; a process check app 116 which is an application for checking processes; a Web image monitor (WIM) 117 which operates as a WEB server (an HTTP server) with respect to a client terminal such as a PC connected to the Internet, and displays various screens on a WEB browser running on the client terminal; and the like.

The processes of the application 130 and the processes of the control service each provide a user service relating to an image forming process, such as copy, a printer, a scanner, and facsimile by inter-process communication through function call, sending of its return value, and sending and receiving of a message.

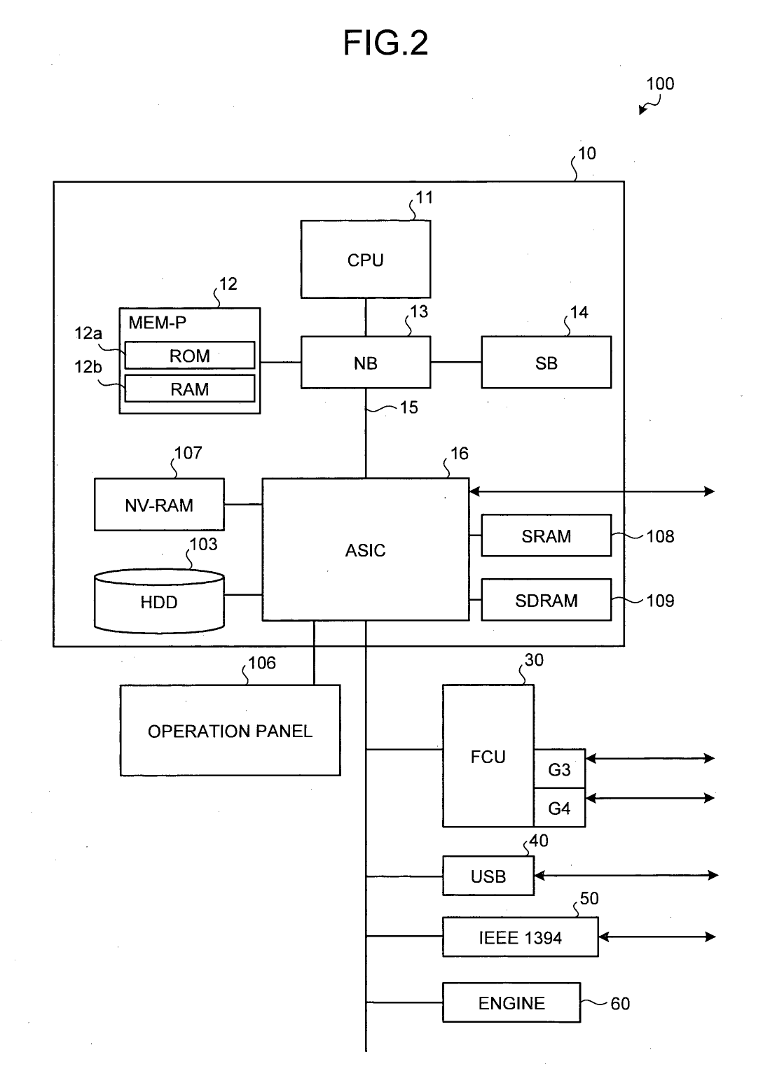

An MFP booting unit 180 is first executed when the MFP 100 is powered on, and runs the application 130 and the platform 120. For example, the MFP booting unit 180 reads out a control service program or an application program from such as an NV-RAM (Non Volatile RAM) 107 (see FIG. 2) as a nonvolatile storage unit, and transfers the read program to a memory area reserved on an SRAM or a SDRAM (Synchronous DRAM) to boot the MFP 100.

In this manner, in the MFP 100 according to the present embodiment, there are a plurality of applications 130 and a plurality of control services, and these all work as a process. Then, in each of these processes, one of a plurality of threads is created, and parallel processing is performed in units of thread(s). Furthermore, the control service provides a common service to the application 130. Namely, in the MFP 100 according to the present embodiment, the plurality of applications 130 and the plurality of control services perform parallel operation of a large number of these processes and parallel operation of threads, and work in a coordinated manner by inter-process communication, thereby providing a user service relating to an image forming process, such as copy, a printer, a scanner, and facsimile.

Furthermore, the MFP 100 according to the present embodiment allows a client of the MFP 100 or a third party such as a third vendor to develop an external app 172 and install the developed external app 172 in the application layer on the control service layer. The external app 172 can be downloaded via a network and installed by an app installation control service or the like.

As described above, in the MFP 100 according to the present embodiment, processes of the plurality of applications 130 and processes of the plurality of control services are operated; alternatively, the processes of the applications 130 and the processes of the control services each can be configured as a single framework. Furthermore, each of the applications 130 can be added or deleted on an application-by-application basis. Namely, as described above, the external app 172 can be installed, and also can be uninstalled.

Subsequently, a concrete example of a hardware configuration of the MFP 100 is explained with reference to FIG. 2. The MFP 100 includes a controller 10 and an engine unit (Engine) 60. The controller 10 and the engine unit 60 are connected by a PCI (Peripheral Component Interconnect) bus. The controller 10 is a controller which controls the entire MFP 100 and controls drawing, communications, and the input from an operating unit (not shown). The engine unit 60 is a printer engine which can be connected to the PCI bus or the like; for example, the engine unit 60 is a black-and-white plotter, a 1-drum color plotter, a 4-drum color plotter, a scanner, a fax unit, or the like. The engine unit 60 includes an image processing part such as for error diffusion and gamma conversion, in addition to a so-called engine part, such as a plotter.

The controller 10 includes a CPU 11, a North Bridge (NB) 13, a system memory (MEM-P) 12, a South Bridge (SB) 14, an ASIC (Application Specific Integrated Circuit) 16, and the hard disk drive (HDD) 103. The NB 13 and the ASIC 16 are connected by an AGP (Accelerated Graphics Port) 15.

The CPU 11 controls the entire MFP 100, and has a chipset composed of the NB 13, the MEM-P 12, and the SB 14. The CPU 11 is connected to other devices via the chipset.

The NB 13 is a bridge for connecting the CPU 11 to the MEM-P 12, the SB 14, and the AGP 15, and includes a memory controller such as for controlling read/write with respect to the MEM-P 12, a PCI master, and an AGP target.

The MEM-P 12 is a system memory used as a memory for storing a program or data, a memory for unpacking the program or data, a memory for drawing by a printer, and the like. The MEM-P 12 includes a ROM (Read Only Memory) 12a and a RAM (Random Access Memory) 12b. The ROM 12a is a read only memory used as a memory for storing a program or data. The RAM 12b is a read-write memory used as a memory for unpacking the program or data, a memory for drawing by a printer, and the like.

The SB 14 is a bridge for connecting the NB 13 to a PCI device and a peripheral device. The SB 14 is connected to the NB 13 via the PCI bus. The communication I/F 105 and the like are also connected to the PCI bus.

The ASIC 16 is an image processing IC (Integrated Circuit) including hardware components for image processing. The ASIC 16 serves as a bridge for connecting the AGP 15, the PCI bus, the HDD 103, the NV-RAM 107, an SRAM 108, an SDRAM 109, and the like. The ASIC 16 has a PCI target, an AGP master, an arbiter (ARB) which is the core of the ASIC 16, a memory controller for controlling the SRAM 108, the SDRAM 109, and the like, a plurality of DMACs (Direct Memory Access Controllers) such as for rotating image data by a hardware logic or the like, and a PCI unit for performing data transfer between the controller 10 and the engine unit 60 via the PCI bus. An FCU (Facsimile Control Unit) 30, a USB (Universal Serial Bus) 40, and an IEEE1394 (the Institute of Electrical and Electronics Engineers 1394) interface 50 are connected to the ASIC 16 via the PCI bus. Furthermore, the operation panel 106 is directly connected to the ASIC 16.

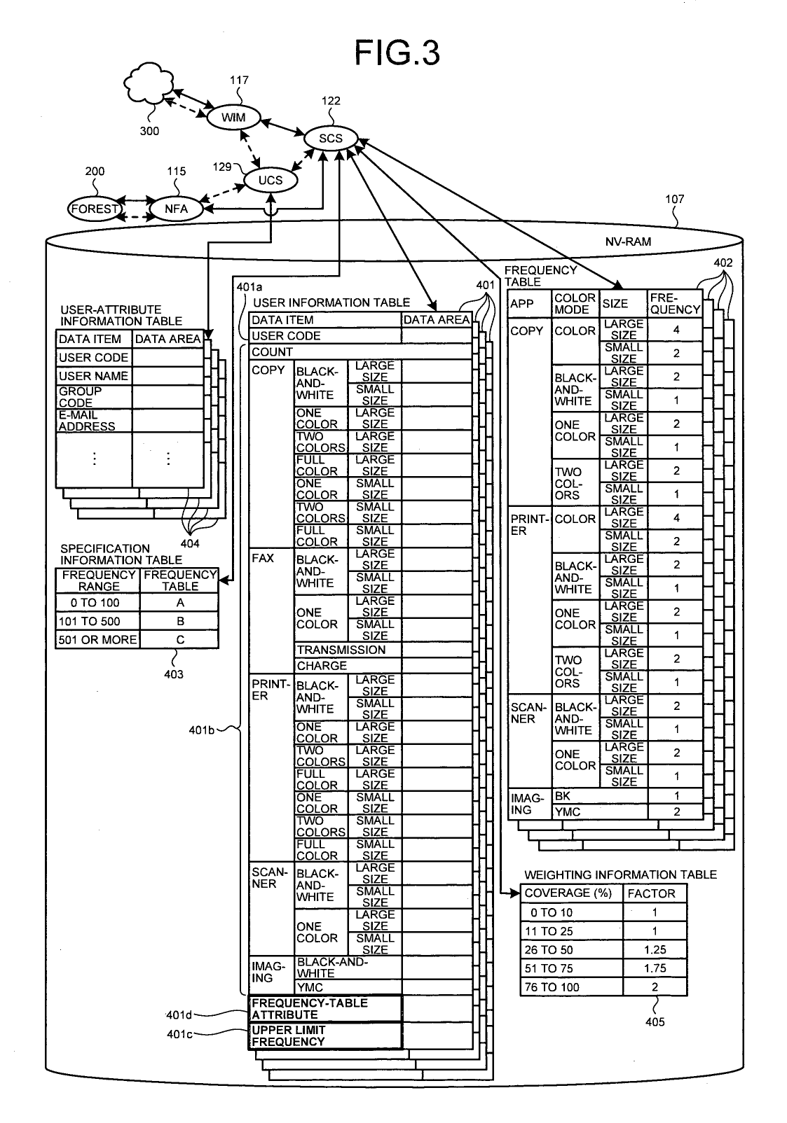

The HDD 103 stores therein image data, a program, font data, a form, delivery address information, and the like. The nonvolatile RAM (NV-RAM) 107 stores therein applications, control services, and programs such as the SRM 123 composing the applications 130 or the platform 120, a user information table 401, a frequency table 402, and the like (see FIG. 3). The SRAM 108 and the SDRAM 109 are used as a copy image buffer, a code buffer, and the like.

The operation panel 106 is an operation display unit for receiving input operation from an operator and displaying a message to the operator thereon.

The AGP 15 is a bus interface for a graphics accelerator card proposed to speed up a graphics process, and accelerates the graphics accelerator card by direct access to the MEM-P 12 at high throughput.

Subsequently, information relating to an acceptance/rejection determining process (such as the tables) stored in the NV-RAM 107 as a storage unit, a procedure to set the information, a procedure to obtain the information, and the like are explained with reference to FIG. 3.

Initialization or setting change (update) of the user information table 401, the frequency table 402, a specification information table 403, a user-attribute information table 404, a weighting information table 405, and the like can be made from terminals (not shown) connected to the MFP 100 via networks such as a forest 200 and the Internet 300. Furthermore, the initialization or setting change (update) can be made through the operation panel 106 of the MFP 100. The forest 200 here means a network in which accounts of a user and a computer are managed and establishes a trusting relationship with the MFP 100.

The initialization or setting change (update) of the user information table 401, the frequency table 402, the specification information table 403, or the weighting information table 405 is executed by the SCS 122. Namely, in the present embodiment, the SCS 122 corresponds to a user-information setting control unit, a frequency-information setting control unit, a specification-information setting control unit, and a weighting-information setting control unit.

When a request for the initialization or setting change (update) of the user information table 401 comes from the forest 200, the request is sent to the UCS 129 via the NFA 115. When a request for the initialization or setting change (update) of the user information table 401 comes from the Internet 300, the request is sent to the UCS 129 via the WIM 117. The UCS 129 executes verification of authorization for the request (determination of whether or not to accept the request), identification of a user with respect to the request, and the like. When the UCS 129 confirms that an account of a requestor has authorization for the initialization or setting change indicated in the request and also identifies a user who requests for the initialization or setting change, the UCS 129 sends the request together with a user code to the SCS 122. In response to the request, the SCS 122 executes the control for performing the initialization or setting change (update) of data in the user information table 401 stored in the NV-RAM 107. Under limited conditions, the request can be sent to the SCS 122 without going through the UCS 129.

Furthermore, when a request for the initialization or setting change (update) of the frequency table 402, the specification information table 403, the weighting information table 405, or the like comes from the forest 200, the request is sent to the SCS 122 via the NFA 115. When a request for the initialization or setting change (update) of the frequency table 402, the specification information table 403, the weighting information table 405, or the like comes from the Internet 300, the request is sent to the SCS 122 via the WIM 117. In response to the request, the SCS 122 executes the control for performing the initialization or setting change (update) of data in the frequency table 402 stored in the NV-RAM 107. The initialization or setting change of the frequency table 402 can be executed through the UCS 129 in the same manner as the case of the user information table 401 described above.

The user information table 401 includes user-specific information (user identification information) 401a, such as a user code, as well as performance information 401b for each user (each user code, in this example). The performance information 401b is classified into categories according to an image forming process (copy, fax, printer, scanner, imaging) and a mode of the image forming process (full color, two colors, one color, size, etc.) As an example, the performance information 401b is stored as a performance frequency (a cumulative frequency, a total frequency) of a predetermined process category within a predetermined period. The performance information 401b can be stored as the number of counts (the number of times of execution of the process).

Furthermore, in the user information table 401, a frequency indicating an upper limit frequency 401c is stored as acceptable-processing-amount information. The upper limit frequency 401c can be set, for example, as a frequency corresponding to a total value of processing performance of all the categories or a plurality of specified categories within a predetermined period (for example, in the predetermined year), or can be set per process or per mode of each process.

Moreover, in the user information table 401, data (for example, 2-bit data) indicating a frequency-table attribute 401d is stored as identification information indicating the frequency table 402 to be referenced in acceptance/rejection determination to be described later out of a plurality of frequency tables 402. The SCS 122 references (obtains) the frequency-table attribute 401d, thereby identifying a frequency table 402 corresponding to the frequency-table attribute 401d.

In the frequency table 402, a frequency is set per image forming process (copy, printer, scanner, imaging) and per mode of the image forming process (full color, two colors, one color, size, etc.). The frequency is a value indicating weighting of each process category of an image forming process. In general, a larger value is set in a category of a process which requires higher cost (unit price).

However, in the present embodiment, a plurality of frequency tables 402 are set. Therefore, by preparing a plurality of frequency tables 402 which differ in values of frequency, weighting with respect to each process category can be changed depending on the situation. Specifically, for example, under the assumption that the MFP 100 is running out of toner for color processing, a frequency table 402 in which a value of weighting (frequency) of color is increased can be set. Furthermore, frequency tables 402 which differ in a value of weighting (frequency) of color according to a user attribute (a business section or division, etc. to which a user belongs) can be set. Namely, with respect to (an account of) a user who often handles the work to output color materials, a frequency table 402 in which a value of weighting (frequency) of color is reduced can be set. Furthermore, to respond to the case where work approval for a specific process is obtained, a frequency table 402 in which a value of weighting (frequency) of a category of the specific process is reduced can be set.

Moreover, a plurality of frequency tables 402 can be set on a per-user basis (i.e., on a per-user code (account) basis). Furthermore, a plurality of types of frequency tables 402 can be shared by a plurality of users. In this case, as described above, the SCS 122 can identify a frequency table 402 to be referenced in acceptance/rejection determination on the basis of the frequency-table attribute 401d as identification information in the user information table 401.

Furthermore, in the present embodiment, a frequency table 402 to be used in determination of acceptance/rejection of a request for a process (to be described later) can be specified from a plurality of frequency tables 402 based on the specification information table 403. In the example of the specification information table 403 shown in FIG. 3, a frequency table 402 used in acceptance/rejection determination is stored to be associated with a range (frequency range) of a performance frequency (a cumulative frequency, a total frequency) within a predetermined period on a per-user (per-user code) basis. For example, when “A” is specified in the specification information table 403 as the frequency table 402, out of a plurality of (three, “A”, “B”, and “C”) frequency tables 402 prepared on a per-user (per-user code) basis, a frequency table 402 corresponding to “A” is selected, and used in determination of acceptance/rejection of a request for a process. In this example, “A” is selected as the frequency table 402 if the performance frequency is low, and “B” or even “C” is selected with increasing the performance frequency. Then, as for the same process category, a frequency in the frequency table 402″B″ is set to be higher than that is in the frequency table 402″A″, and a frequency in the frequency table 402″C″ is set to be higher than that is in the frequency table 402″B″. By such settings, to a user (a user code) whose performance frequency in a predetermined period is higher, a frequency table 402 in which a higher frequency is set is used in determination of acceptance/rejection of a request for a process. The higher the frequency set in the frequency table 402 is, the less likely the request for the process is to be accepted in the acceptance/rejection determination; therefore, by such settings, a request for a process is less likely to be accepted with increasing a performance frequency in a predetermined period, and, eventually, this makes it easy to achieve advantageous effects, such as reduction in consumption of consumables and reduction in cost.

Furthermore, information of the specification information table 403 can be rewritten. That is, for example, information of the specification information table 403 is rewritten by an account holder authorized to rewrite the information (for example, an administrator or the like) depending on the situation, so that the effects of reduction in consumption of consumables and reduction in cost, etc. can be enhanced relatively easily.

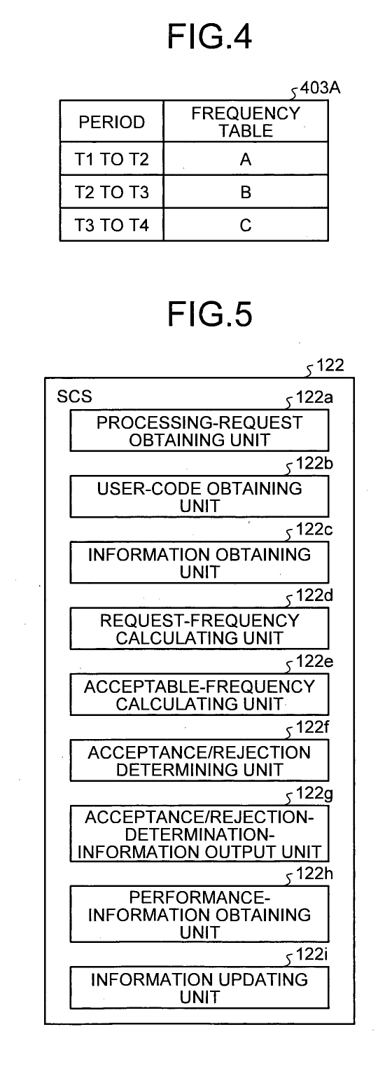

Moreover, the specification information table 403 is not limited to that is shown in FIG. 3, and the specification information table 403 can include different information as long as the specification information table 403 is an indicator for selecting a frequency table 402. Specifically, for example, the specification information table 403 can be a table in which data indicating a classification of a user code, such as a group code (a department code) or a rank code (a position code), and data identifying a frequency table 402 are stored in an associated manner. In this case, the accessibility to the MFP 100 can differ according to the department or position, etc. This is because when a higher frequency is set, a request for a process is less likely to be accepted; on the other hand, when a lower frequency is set, a request for a process is more likely to be accepted. Furthermore, for example, as shown in FIG. 4, a specification information table 403A can be a table in which data indicating a period (a term, a date, a time, or a time slot, etc., T1 to T4) and data identifying a frequency table 402 are stored in an associated manner. In this case, the accessibility to the MFP 100 can differ according to the period. The specification information table 403 and a frequency-table attribute 401d which identify a frequency table 402 can be used with priority on either one of the two, or any of the two to be used can be specified (selected), or the two can be used in combination.

In the weighting information table 405, a factor (a weighting factor) is stored to be associated with a range of coverage in an image forming process (for example, a ratio of an actually-printed area to a whole printing area, etc., %). When a performance frequency of an executed image forming process is added to the performance information 401b (a performance frequency) of the user information table 401, the performance frequency of the image forming process is multiplied by the factor. In the example shown in FIG. 3, the higher the coverage of an image forming process performed, the greater the performance information 401b (the performance frequency).

The initialization or setting change (update) of a user-attribute information table 404 is executed by the UCS 129. The user-attribute information table 404 includes information on attributes of a user, such as a user name, a group code, and an e-mail address, on a per-user code (account) basis.

Subsequently, a procedure to determine whether or not to accept a request for a process relating to image processing in the MFP 100 is explained with reference to FIGS. 5 to 7.

An acceptance/rejection determining process for determining whether or not to accept a request for a process relating to image formation is mainly performed by the SCS 122. As shown in FIG. 5, the SCS 122 operates as a processing-request obtaining unit 122a, a user-code obtaining unit 122b, an information obtaining unit 122c, a request-frequency calculating unit 122d, an acceptable-frequency calculating unit 122e, an acceptance/rejection determining unit 122f, an acceptance/rejection-determination-information output unit 122g, a performance-information obtaining unit 122h, and an information updating unit 122i. The operation of these units is realized by a program.

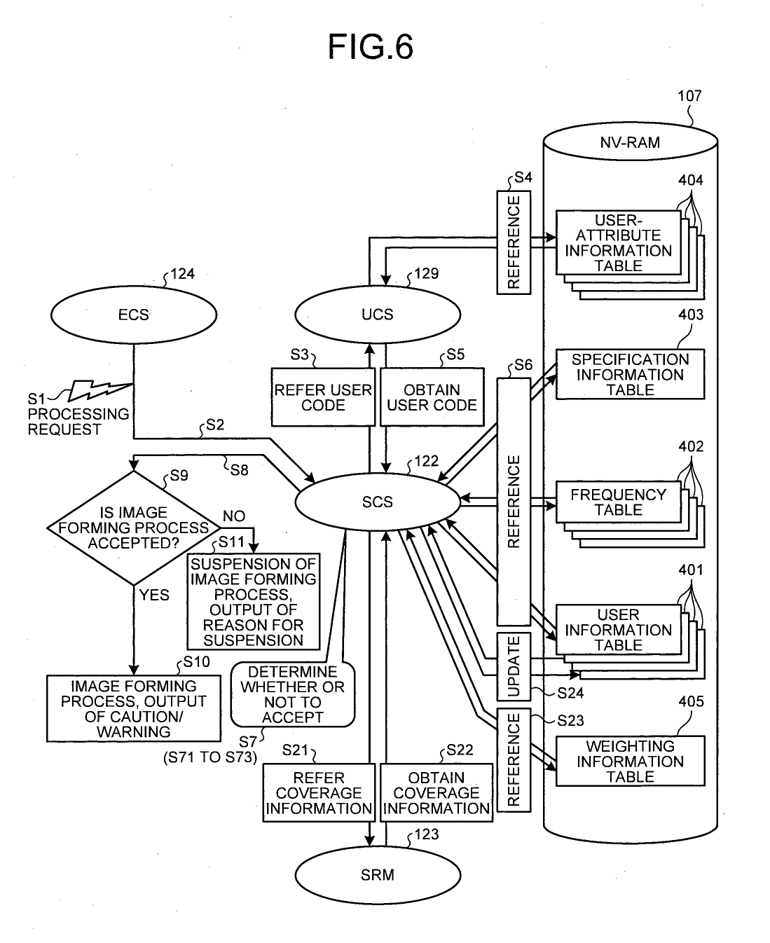

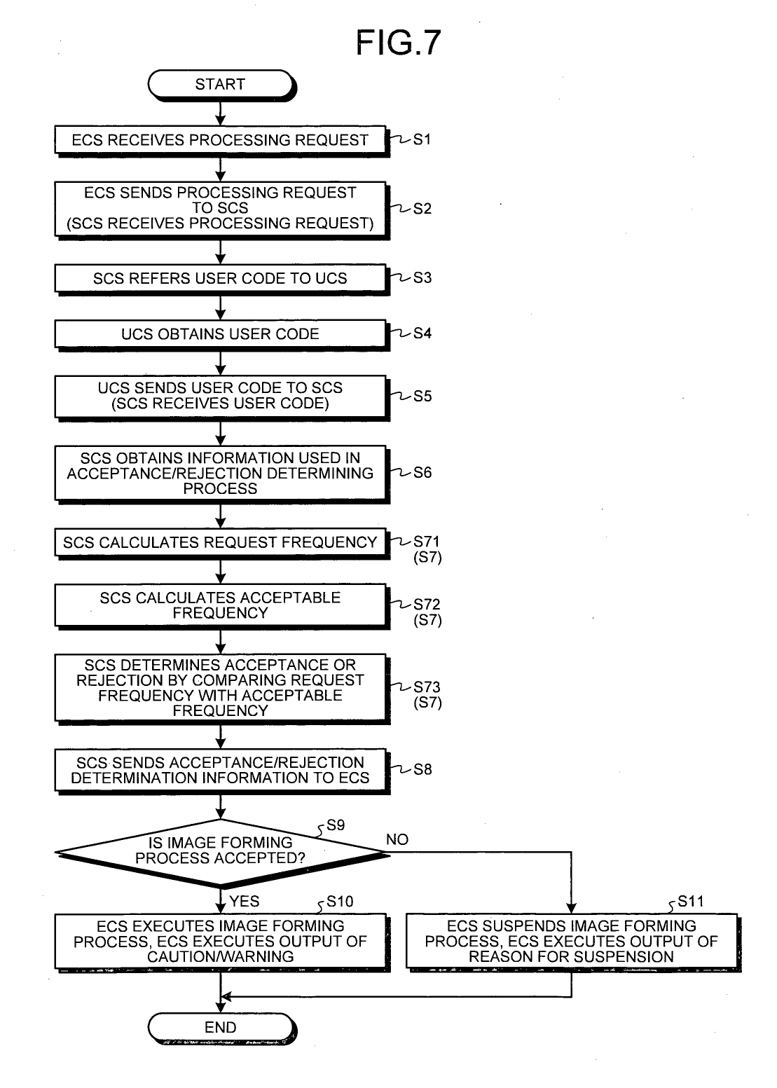

As shown in FIGS. 6 and 7, when the ECS 124 receives a processing request such as a print request (Step S1), the ECS 124 sends the processing request to the SCS 122. At this time, the SCS 122 operates as the processing-request obtaining unit 122a, and receives the processing request (Step S2). Then, the SCS 122 operates as the user-code obtaining unit 122b, and refers a user code corresponding to the processing request to the UCS 129 (Step S3). The UCS 129 obtains a user code from user-attribute information tables 404 (Step S4), and sends the obtained user code to the SCS 122. At this time, the SCS 122 operates as the user-code obtaining unit 122b, and receives the user code from the ECS 124 (Step S5). Then, the SCS 122 operates as the information obtaining unit 122c, and obtains information required for the acceptance/rejection determining process with reference to a corresponding user information table 401, a corresponding frequency table 402, and the specification information table 403 in the NV-RAM 107 (Step S6).

At Step S6, when a frequency table 402 used in determination of acceptance/rejection of the processing request is specified in the specification information table 403 as described above, the SCS 122 operating as the information obtaining unit 122c obtains information (a frequency) corresponding to the processing request from the frequency table 402 specified in the specification information table 403. At Step S6, such as when a frequency table 402 is not specified in the specification information table 403, the SCS 122 operating as the information obtaining unit 122c can obtain a frequency-table attribute 401d as identification information from the user information table 401, and obtain a frequency of a category of the requested process from a frequency table 402 corresponding to the frequency-table attribute 401d.

For example, in the example of the frequency table 402 shown in FIG. 3, in response to a request for a “color” printing process (“printer”) and “large” paper size, the SCS 122 obtains “4” as a frequency of a category of the process.

Furthermore, at Step S6, the SCS 122 operating as the information obtaining unit 122c obtains a performance frequency corresponding to the processing request with reference to performance information 401b in the user information table 401. When the performance information 401b is set to a frequency of a plurality of process categories or a frequency of all the process categories, the SCS 122 operating as the information obtaining unit 122c obtains a value of the frequency of the plurality of process categories or a value of the frequency of all the process categories corresponding to the performance information 401b, or a total value of them. Moreover, the SCS 122 further obtains the upper limit frequency 401c from the user information table 401.

Then, the SCS 122 determines whether or not to accept the processing request (Step S7). Specifically, the SCS 122 operates as the request-frequency calculating unit 122d, and calculates a request frequency by multiplying the number of processes (for example, the number of color copies) by the value of the frequency obtained from the frequency table 402 (Step S71). Furthermore, the SCS 122 operates as the acceptable-frequency calculating unit 122e, and calculates an acceptable frequency by subtracting a value of the performance frequency from a value of the upper limit frequency 401c based on such as the upper limit frequency 401c and the performance information 401b within the predetermined period in the user information table 401 (Step S72). Then, the SCS 122 operates as the acceptance/rejection determining unit 122f, and compares the request frequency with the acceptable frequency; if the request frequency is less than or equal to the acceptable frequency, the SCS 122 determines “acceptance of the image forming process”, on the other hand, if the request frequency exceeds the acceptable frequency, the SCS 122 determines “rejection of the image forming process” (Step S73). Namely, in the present embodiment, the SCS 122 corresponds to a request-frequency calculating unit, an acceptable-frequency calculating unit, and an acceptance/rejection determining unit. Then, the SCS 122 operates as the acceptance/rejection-determination-information output unit 122g, and sends a result of the determination to the ECS 124 (Step S8).

Then, the ECS 124 executes a different process depending on the result of the determination to (Step S10 or S11). Namely, when the result of the determination by the SCS 122 is “acceptance of the image forming process” (YES at Step S9), the ECS 124 controls execution of the image forming process in accordance with the processing request (Step S10). Furthermore, if a difference between the acceptable frequency and the performance frequency is small, at Step S10, for example, the ECS 124 can control the operation panel 106 via the OCS 126 to display (output) a caution or a warning such as “Approaching the allowable limit. Consider saving usage.”

On the other hand, when the result of the determination by the SCS 122 is “rejection of the image forming process” (NO at Step S9), the ECS 124 suspends the image forming process, and controls the operation panel 106 via the OCS 126 to display (output) a predetermined message (Step S11). Specifically, for example, a reason for the suspension such as “The process is rejected due to over the allowable limit.” can be displayed (output) on the operation panel 106.

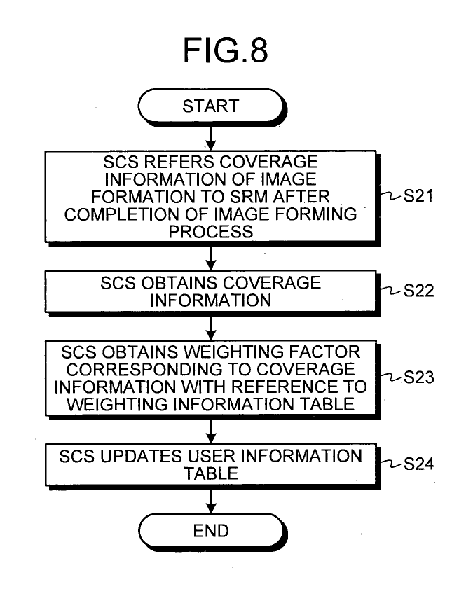

When the image forming process (Step S10 in FIG. 7) is completed, update of the performance information 401b (the performance frequency) in the user information table 401 is executed according to a procedure shown in FIG. 8. First, the SCS 122 operates as the performance-information obtaining unit 122h, and refers coverage information of the completed image forming process to the SRM 123 (Step S21). The SCS 122 obtains coverage information from the SRM 123 as a response to Step S21 (Step S22). In the present embodiment, the coverage information corresponds to information on records of used consumables. Processing performance information obtained at Steps S21 and S22 is not limited to the coverage information; for example, the processing performance information can be the sheet size, the number of sheets, or an amount of toner used, etc.

Then, the SCS 122 operates as the information updating unit 122i, and obtains a factor (a weighting factor) corresponding to the coverage information obtained at Step S22 with reference to the weighting information table 405 (Step S23). Then, the SCS 122 operating as the information updating unit 122i adds a performance frequency that the performance frequency is multiplied by the factor to the performance information 401b in the user information table 401, thereby updating the user information table 401 (the performance frequency) (Step S24). Consequently, the usage situation can be reflected in the performance information 401b more accurately, so the MFP 100 which a plurality of users use can execute a more efficient image forming process. In the present embodiment, the information updating unit 122i corresponds to a second performance-frequency changing unit.

Furthermore, at Step S24, a performance frequency in a predetermined period can be obtained from the performance information 401b, and the performance frequency to be added can be increased in such a manner that the higher the performance frequency in the predetermined period is, the greater factor the performance frequency is multiplied by. This makes it possible to prompt a heavy user to save usage. In the present embodiment, the information updating unit 122i corresponds to a performance-frequency changing unit.

As described above, in the MFP 100 as an information processing apparatus (an image forming apparatus) according to the present embodiment, a plurality of frequency tables 402 as frequency information of each process category of an image forming process are set, and the SCS 122 as a request-frequency calculating unit calculates a frequency of a request for a process with reference to any one of the plurality of frequency tables 402 selectively, and then the SCS 122 as a acceptance/rejection determining unit determines whether or not to accept the request by comparing the request frequency with an acceptable frequency. Therefore, weighting of a process category can be more easily set or changed according to various situations, so an acceptable amount of processing relating to image formation can be managed more easily and more efficiently.

Furthermore, in the present embodiment, user code-specific frequency tables 402 are set, so an acceptable amount of processing relating to image formation can be managed more easily and more efficiently according to an attribute of a user.

Moreover, in the present embodiment, on a per-user basis, a plurality of frequency tables 402 can be used, so an acceptable amount of processing relating to image formation can be more easily and more efficiently managed on a per-user basis according to various situations.

Furthermore, in the embodiment where a request frequency is calculated from a frequency table 402 selected according to a performance frequency corresponding to each user code, it can be set, for example, that restriction on the use of the MFP 100 is set to a user whose performance frequency is high and also a user whose performance frequency is low is allowed to use the MFP 100. In this case, there are advantages in terms of work management, such as that it becomes easier to more efficiently allocate an amount of processing relating to image formation, which is defined on the basis of cost, etc. in the MFP 100, among a plurality of users, and it becomes easier to manage cost and usage of consumables due to the use of the MFP 100.

Moreover, in the embodiment where a request frequency is calculated from a frequency table 402 selected based on the specification information table 403A which specifies a frequency table 402 on a per-period basis, it becomes easier to manage an amount of processing relating to image formation on a per-period basis. Namely, it can be more easily set, for example, that when work is busy, an amount of processing relating to relating to image formation is allocated among many users, or when particular work is busy, a more amount of processing relating to image formation is allocated to users involved in the particular work.

Furthermore, in the embodiment where a request frequency is calculated from a frequency table 402 selected based on the rewritable specification information table 403 which specifies a frequency table 402, there are advantages in terms of work management, such as that processing relating to image formation by a user is restricted by the administrator's intention, and it becomes easier to manage cost and usage of consumables due to the use of the MFP 100.

Moreover, in the present embodiment, with reference to a frequency-table attribute 401d as identification information included in a user information table 401, frequency information used in an acceptance/rejection determining process can be obtained more easily and more certainly.

Furthermore, in the present embodiment, by setting an upper limit frequency 401c as acceptable-processing-amount information on a per-user code basis, the SCS 122 operating as the acceptable-frequency calculating unit can more easily and more efficiently manage an amount of processing relating to image formation according to an attribute of a user.

Moreover, in the present embodiment, an acceptable frequency is calculated by subtracting a frequency of performance of an image forming process in a predetermined period from an upper limit frequency in the predetermined period, so there are advantages in terms of work management, such as that it becomes easier to manage cost and usage of consumables due to the use of the MFP 100 on a per-period basis.

Furthermore, in the embodiment where a performance frequency is increased or reduced on the basis of a performance frequency in a predetermined period, for example, it can be set, for example, that restriction on the use of the MFP 100 is set to a user whose performance frequency is high and also a user whose performance frequency is low is allowed to use the MFP 100. In this case, there are advantages in terms of work management, such as that it becomes easier to more efficiently allocate an amount of processing relating to image formation, which is defined on the basis of cost, etc. in the MFP 100, among a plurality of users, and it becomes easier to manage cost and usage of consumables due to the use of the MFP 100.

Moreover, in the embodiment where a performance frequency in a predetermined period is increased or reduced according to information on records of consumables used in each image forming process, it is possible to keep track of usage of consumables in each image forming process more accurately, so it becomes easier to more minutely manage an amount of processing relating to image formation defined on the basis of cost, etc.

In the embodiment described above, the MFP 100 executes, for example, a program built into the ROM or the like in advance, thereby realizing the above-described functions relating to the present invention. The program executed by the MFP 100 is composed of modules including a program for realizing the above-described units of the MFP 100 (the processing-request obtaining unit 122a, the user-code obtaining unit 122b, the information obtaining unit 122c, the request-frequency calculating unit 122d, the acceptable-frequency calculating unit 122e, the acceptance/rejection determining unit 122f, the acceptance/rejection-determination-information output unit 122g, the performance-information obtaining unit 122h, and the information updating unit 122i, etc.). The CPU (the processor) as actual hardware reads out the program from the ROM, and executes the program, thereby loading the program for realizing the above units (functional units) on the main memory, and the above units are realized.

Furthermore, the program executed by the MFP 100 according to the above embodiment can be stored in a computer-readable recording medium, such as a CD-ROM, a flexible disk (FD), a CD-R, or a DVD (Digital Versatile Disk), in an installable or executable file format, and the recording medium can be provided.

Moreover, the program executed by the MFP 100 according to the above embodiment can be stored on a computer connected to a network such as the Internet, and the program can be provided by causing a user to download the program via the network. Furthermore, the program executed by the MFP 100 according to the above embodiment can be provided or distributed via a network such as the Internet.

Furthermore, in the above embodiment, there is described an example in which the information processing apparatus (the image forming apparatus) according to the present invention is applied to an MFP having at least two of a copy function, a printer function, a scanner function, and a facsimile function; however, the information processing apparatus (the image forming apparatus) according to the present invention can be applied to any image forming apparatuses such as a copier, a printer, a scanner device, and a facsimile machine.

Moreover, the present invention is not limited to the above embodiment, and various variations can be made. For example, the storage unit can store therein an acceptable frequency per process as an acceptable processing amount, and the acceptance/rejection determining unit can execute acceptance/rejection determination by comparing a request frequency with the acceptable frequency obtained from the storage unit. Furthermore, there is no need to change a performance frequency each time an image forming process is completed; alternatively, a performance frequency can be changed at specified timing (for example, at intervals of a predetermined period). Moreover, change of the performance frequency and update of the performance frequency can be performed separately. Furthermore, there is no need to perform selection of frequency information prior to the start of an image forming process; alternatively, frequency information can be selected each time an image forming process is completed or at specified timing (for example, at intervals of a predetermined period). In this case, identification information (a frequency-table attribute) indicating the selected frequency information is stored in a predetermined storage unit, and the frequency information specified by the identification information is used in acceptance/rejection determination.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An information processing apparatus comprising:
a request-frequency calculating unit that calculates a request frequency corresponding to a processing request relating to image formation with reference to any one of multiple pieces of frequency information, which is broken down by process category of an image forming process and stored in a predetermined storage unit, selectively;
an acceptable-frequency calculating unit that calculates an acceptable frequency corresponding to the processing request from acceptable-processing-amount information stored in a predetermined storage unit; and
an acceptance/rejection determining unit that determines whether or not to accept the processing request by comparing the request frequency with the acceptable frequency.

2. The information processing apparatus according to claim 1, wherein
the frequency information is set on a per-user code basis, and
the request-frequency calculating unit calculates the request frequency from the frequency information corresponding to a user code corresponding to the processing request.

3. The information processing apparatus according to claim 2, wherein
multiple pieces of frequency information are set on a per-user code basis, and
the request-frequency calculating unit calculates the request frequency from the frequency information corresponding to the user code selected from the multiple pieces of frequency information.

4. The information processing apparatus according to claim 1, wherein the request-frequency calculating unit calculates the request frequency from the frequency information selected according to a performance frequency of the image forming process stored in a predetermined storage unit on a per-user code basis.

5. The information processing apparatus according to claim 1, wherein the request-frequency calculating unit calculates the request frequency from the frequency information selected based on specification information which is stored in a predetermined storage unit and specifies the frequency information on a per-period basis.

6. The information processing apparatus according to claim 1, wherein the request-frequency calculating unit calculates the request frequency from the frequency information selected based on rewritable specification information which is stored in a predetermined storage unit and specifies the frequency information.

7. The information processing apparatus according to claim 2, wherein the request-frequency calculating unit calculates the request frequency from the frequency information selected from the multiple pieces of frequency information based on identification information stored in a predetermined storage unit on a per-user code basis.

8. The information processing apparatus according to claim 1, wherein
the acceptable-processing-amount information is set on a per-user code basis, and
the acceptable-frequency calculating unit calculates the acceptable frequency from the acceptable-processing-amount information corresponding to a user code corresponding to the processing request.

9. The information processing apparatus according to claim 1, wherein the acceptable-frequency calculating unit calculates the acceptable frequency by subtracting a performance frequency of the image forming process in a predetermined period stored in a predetermined storage unit from an upper limit frequency in the predetermined period stored in a predetermined storage unit.

10. The information processing apparatus according to claim 9, further comprising a performance-frequency changing unit that increases or reduces the performance frequency on the basis of the performance frequency in the predetermined period.

11. The information processing apparatus according to claim 9, further comprising a second performance-frequency changing unit that increases or reduces the performance frequency in the predetermined period according to information on records of consumables used in each image forming process.

12. A computer-readable, non-transitory storage medium storing a program causing a computer to execute:
calculating a request frequency corresponding to a processing request relating to image formation with reference to any one of multiple pieces of frequency information which is broken down by process category of an image forming process and stored in a predetermined storage unit, selectively;
calculating an acceptable frequency corresponding to the processing request from acceptable-processing-amount information stored in a predetermined storage unit; and
determining whether or not to accept the processing request by comparing the request frequency with the acceptable frequency.
